(19) United States
(12) Patent Application Publication
(10) Pub. No.: US 2018/0204106 A1
(43) Pub. Date: Jul. 19, 2018

(54) SYSTEM AND METHOD FOR PERSONALIZED DEEP TEXT ANALYSIS

(71) Applicant: INTERNATIONAL BUSINESS MACHINES CORPORATION, Armonk, NY (US)

(72) Inventors: Charles E. BELLER, Baltimore, MD (US); Richard L. DARDEN, Leesburg, VA (US); Sakthi PALANI, Palatine, IL (US); Yashavant SINGH, Ashburn, VA (US)

(21) Appl. No.: 15/406,917

(22) Filed: Jan. 16, 2017

(51) Int. Cl. G06N 3/00; G06F 17/24; G06F 17/22; G06F 17/27; G06F 17/21; G06N 7/00; G06N 99/00

(52) U.S. Cl. CPC G06N 3/006; G06F 17/241; G06F 17/2211; G06N 99/005; G06F 17/218; G06F 17/278; G06N 7/005; G06F 17/2705

(57) ABSTRACT

A system includes a deep question answering system executed by a computer, a processor, and a memory coupled to the processor. The memory is encoded with instructions that when executed cause the processor to provide a document ingestion system for ingesting user specific documents into the deep question answering system. The document ingestion system is configured to initialize a user specific document collection, the user specific document collection being specific to a user, obtain an indication that the user is interested in a first document based on an interaction between the user and a shallow analytic system, include the first document in the user specific document collection, and ingest the user specific document collection into the deep question answering system.

### STATEMENT REGARDING FEDERALLY SPONSORED RESEARCH OR DEVELOPMENT

This invention was made with Government support under Agreement No. 2013-12101100008 awarded by The Department of Defense. The Government has certain rights to this invention.

### STATEMENT REGARDING PRIOR DISCLOSURES BY THE INVENTOR OR A JOINT INVENTOR

N/A.

### BACKGROUND

The present invention relates to cognitive computing systems, and more specifically, to techniques and mechanisms for ingesting personalized documents into a deep question answering system for use by the deep question answering system in answering natural language questions.

With the increased usage of computing networks, such as the Internet, users can easily be overwhelmed with the amount of information available from various structured and unstructured sources. However, information gaps abound as users try to piece together what they believe to be relevant during searches for information on various subjects. To assist with such searches, research has been directed to creating cognitive systems such as Question and Answer (QA) systems that take an input question, analyze the question, and return results indicative of the most probable answer or answers to the input question. QA systems provide automated mechanisms for searching through large sets of sources of content, e.g., electronic documents, and analyze them with regard to an input question to determine an answer to the question and a confidence measure as to how accurate an answer to the question might be.

The IBM Watson™ system available from International Business Machines (IBM) Corporation of Armonk, N.Y. offers several services that can be used to build such QA systems. The IBM Watson™ system is an application of advanced natural language processing, information retrieval, knowledge representation and reasoning, and machine learning technologies to the field of open domain question answering.

### SUMMARY

According to an embodiment, a method includes initializing a user specific document collection. The user specific document collection is specific to a user. An embodiment of the method includes monitoring an interaction between the user and the first document in the shallow analytic system. The method also includes obtaining an indication that the user is interested in a first document based on the interaction between the user and the shallow analytic system. In an embodiment of the method, the indication that the user is interested in the first document is an indirect indication. In an embodiment of the method, the indirect indication is based on a number of times the user visits the first document, an amount of active time the user spends with the first document, or a similarity between the first document to a second document that is included in the user specific document collection. In an embodiment of the method, the indication that the user is interested in the first document is a direct indication from the user to include the first document in the user specific document collection. The method also includes including the first document in the user specific document collection. The method also includes ingesting the user specific document collection into a deep question answering system. In an embodiment of the method, ingesting the user specific document collection includes running one or more text analytic algorithms over raw text in the first document and storing annotations generated by the one or more text analytic algorithms in memory accessible to the deep question answering system. An embodiment of the method includes receiving a question from the user, generating a first answer to the question, and generating a first confidence score for the first answer. In an embodiment of the method, the first confidence score is based on the first answer being generated from any document in the user specific document collection. An embodiment of the method includes generating a second answer to the question and generating a second confidence score for the second answer. In an embodiment of the method, the second confidence score is based on the second answer being generated from any document not in the user specific document collection. In an embodiment of the method, the second confidence score is less than the first confidence score.

In another embodiment, a system/apparatus is provided. The system/apparatus includes a deep question answering system executed by a computer, one or more processors, and memory. The memory is encoded with instructions that when executed cause the one or more processors to provide a document ingestion system for ingesting user specific documents into the deep question answering system. The document ingestion system may be configured to perform various ones of, and various combinations of the operations described above with respect to embodiments of a method.

In a further embodiment, a computer program product including a computer readable storage medium encoded with program instructions is provided. The program instructions are executable by a computer to cause the computer to perform various ones of, and various combinations of the operations described above with respect to embodiments of a method.

### BRIEF DESCRIPTION OF THE DRAWINGS

FIG. 1 shows an illustrative block diagram of a system that provides answers to natural language questions in accordance with various embodiments;

FIG. 2 shows an illustrative block diagram of a question answering system for answering natural language questions in accordance with various embodiments;

FIG. 3 shows a flow diagram illustrating aspects of operations that may be performed to ingest user specific documents into a deep question answering system in accordance with various embodiments;

FIG. 4 shows a flow diagram illustrating aspects of operations that may be performed to identify user specific documents to include for ingestion into a deep question answering system in accordance with various embodiments;

FIG. 5 shows a flow diagram illustrating aspects of operations that may be performed to ingest user specific documents into a deep question answering system in accordance with various embodiments;

FIG. 6 shows a flow diagram illustrating aspects of operations that may be performed to answer natural language questions utilizing a deep question answering system in accordance with various embodiments; and

FIG. 7 shows an illustrative block diagram of an example data processing system that can be applied to implement embodiments of the present disclosure.

### DETAILED DESCRIPTION

The quality of the responses provided by a QA system is tied to the question provided to the system and the documents the system can access to determine the answer. In many QA systems, the documents the QA system accesses to answer a user's question is limited to documents that have already been ingested into the system. In many QA systems, users are not able to specify specific documents that the QA system can access to answer a particular question. Therefore, it is desirable to develop a system for ingesting user indicated documents into a QA system to provide a personalized answer to a user generated question. In accordance with various examples, a system may be provided that obtains direct or indirect indications that a user is interested in a document based on the user's interactions with a shallow analytic system. Documents which the system determines are of interest to the user then may be ingested into the QA system. The QA system may access the ingested user specific documents to provide personalized answers to input questions. In this way, the system may improve natural language processing.

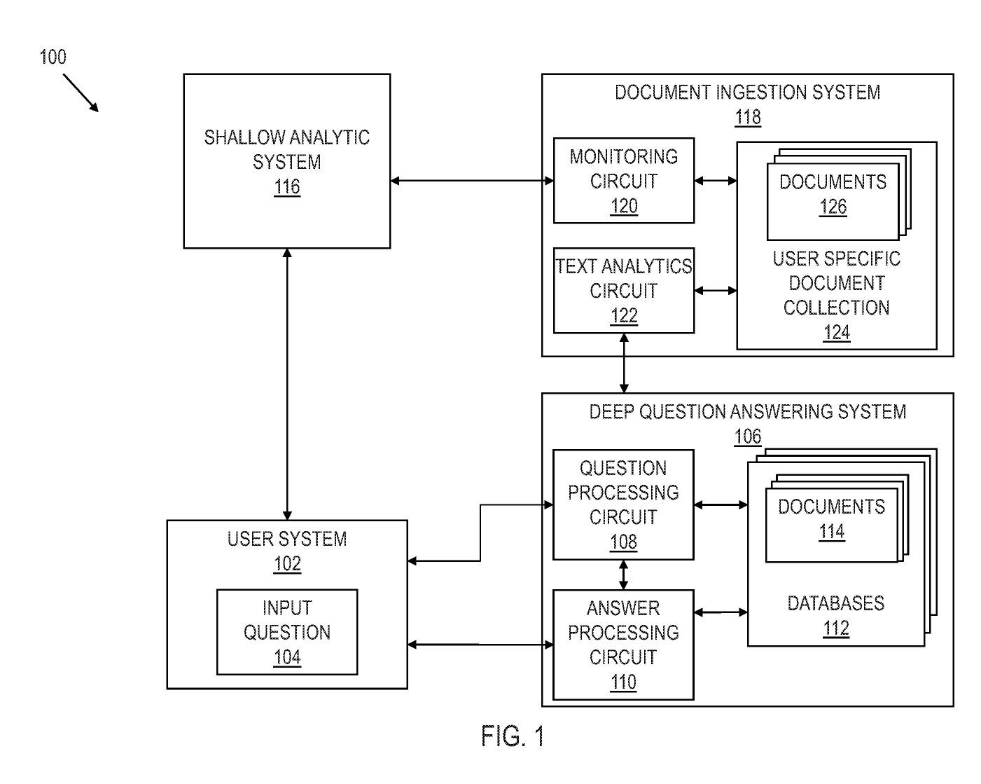

FIG. 1 shows a block diagram of a system 100 that answers natural language questions in accordance with various embodiments. The system 100 includes a user system 102, a deep question answering (QA) system 106, a shallow analytic system 116, and a document ingestion system 118. The QA system 106 is a system configured to answer questions, such as input question 104, received from user system 102. In some embodiments, the question 104 may take the form of a natural language question. For example, the question 104 may be, “Which basketball team is from New York?” The QA system 106 is illustrative and is not intended to state or imply any limitation with regard to the type of QA mechanisms with which various embodiments may be implemented. Many modifications to the example QA system 100 may be implemented in various embodiments.

The system 100, including the user system 102, the QA system 106, the shallow analytic system 116, and the document ingestion system 118, may be implemented on one or more computing devices (comprising one or more processors and one or more memories, and optionally including any other computing device elements generally known in the art including buses, storage devices, communication interfaces, and the like).

The QA system 106 operates by accessing information from a corpus of data or information (also referred to as a corpus of content), analyzing it, and then generating answer results based on the analysis of this data. Accessing information from a corpus of data typically includes: a database query that answers questions about what is in a collection of structured records, and a search that delivers a collection of document links in response to a query against a collection of unstructured data (text, markup language, etc.). Conventional question answering systems are capable of generating answers based on the corpus of data and the input question, verifying answers to a collection of questions for the corpus of data, correcting errors in digital text using a corpus of data, and selecting answers to questions from a pool of potential answers, i.e., candidate answers.

The QA system 106 includes question processing circuit 108, answer processing circuit 110, and databases 112. The databases 112 store documents 114 that serve as at least a part of the corpus of data from which answers to questions are derived. The documents 114 may include any file, text, article, or source of data for use in the QA system 106. The question processing circuit 108 receives input questions to be answered by the QA system 106. The input questions may be formed using natural language. The input questions may be received from the user system 102. The user system 102 may be coupled to the QA system 106 via a network, such as a local area network, a wide area network, the internet, or other communication system.

In some illustrative embodiments, the QA system 106 may be the IBM Watson™ QA system available from International Business Machines Corporation of Armonk, N.Y. The IBM Watson™ QA system may receive an input question, such as question 104, which it then parses to extract the major features of the question, that in turn are then used to formulate queries that are applied to the corpus of data. Based on the application of the queries to the corpus of data, a set of hypotheses, or candidate answers to the input question, are generated by looking across the corpus for portions of the corpus of data that have some potential for containing a valuable response to the input question.

The IBM Watson™ QA system analyzes the language of the input question and the language used in each of the portions of the corpus of data found during the application of the queries using a variety of reasoning algorithms. There may be hundreds or even thousands of reasoning algorithms applied, each of which performs different analysis, e.g., comparisons, and generates a score. For example, some reasoning algorithms may look at the matching of terms and synonyms within the language of the input question and the found portions of the corpus of data. Other reasoning algorithms may look at the database from which the documents are generated.

The scores obtained from the various reasoning algorithms indicate the extent to which the potential response is inferred by the input question based on the specific area of focus of that reasoning algorithm. Each resulting score is then weighted against a statistical model. The statistical model captures how well the reasoning algorithm performed at establishing the inference between two similar passages for a particular domain during the training period of the IBM Watson™ QA system. The statistical model may then be used to summarize a level of confidence that the IBM Watson™ QA system has regarding the evidence that the potential response, i.e., candidate answer, is inferred by the question. This process may be repeated for each of the candidate answers until the IBM Watson™ QA system identifies candidate answers that surface as being significantly stronger than others and thus, generates a final answer, or ranked set of answers, for the question 104.

The question processing circuit 108 receives input question 104 that is presented in a natural language format. That is, a user of the user system 102 may input, via a user interface, an input question to obtain an answer. For example, a user may input the question, “Which basketball team is from New York?” into the user system 102. In response to receiving the input question from the user system 102, the question processing circuit 108 parses the input question 104 using natural language processing techniques to extract major features from the input question 104, classify the major features according to types, e.g., names, dates, or any of a variety of other defined topics. The identified major features may then be used to decompose the question 104 into one or more queries that may be submitted to the databases 112 in order to generate one or more hypotheses. The queries may be generated in any known or later developed query language, such as the Structure Query Language (SQL), or the like. The queries may be submitted to one or more databases 112 storing the documents 114 and other information.

The queries may be submitted to one or more databases 112 storing information about the electronic texts, documents, articles, websites, and the like, that make up the corpus of data/information. The queries are submitted to the databases 112 to generate results identifying potential hypotheses for answering the input question 104. That is, the submission of the queries results in the extraction of portions of the corpus of data/information matching the criteria of the particular query. These portions of the corpus are analyzed and used to generate hypotheses for answering the input question 104. These hypotheses are also referred to herein as “candidate answers” for the input question 104. For any input question, there may be hundreds of hypotheses or candidate answers generated that need to be evaluated.

The answer processing circuit 110 analyzes and compares the language of the input question 104 and the language of each hypothesis or “candidate answer” as well as performs evidence scoring to evaluate the likelihood that a particular hypothesis is a correct answer for the input question. As mentioned above, this process may involve using a plurality of reasoning algorithms, each performing a separate type of analysis of the language of the input question and/or content of the corpus that provides evidence in support of, or not, of the hypothesis. Each reasoning algorithm generates a score based on the analysis it performs which indicates a measure of relevance of the individual portions of the corpus of data/information extracted by application of the queries as well as a measure of the correctness of the corresponding hypothesis, i.e., a measure of confidence in the hypothesis.

The answer processing circuit 110 may synthesize the large number of relevance scores generated by the various reasoning algorithms into confidence scores for the various hypotheses. This process may involve applying weights to the various scores, where the weights have been determined through training of the statistical model employed by the QA system 106. The weighted scores may be processed in accordance with a statistical model generated through training of the QA system 106 that identifies a manner by which these scores may be combined to generate a confidence score or measure for the individual hypotheses or candidate answers. This confidence score or measure summarizes the level of confidence that the QA system 106 has about the evidence that the candidate answer is inferred by the input question 104, i.e., that the candidate answer is the correct answer for the input question 104.

In the answer processing circuit 110, the resulting confidence scores or measures may be compared against predetermined thresholds, or other analysis may be performed on the confidence scores to determine which hypotheses/candidate answers are most likely to be the answer to the input question 104. The hypotheses/candidate answers may be ranked according to these comparisons to generate a ranked listing of hypotheses/candidate answers (hereafter simply referred to as “candidate answers”). From the ranked listing of candidate answers, a final answer and confidence score, or final set of answers and confidence scores, may be generated and returned to the user system 102.

In some embodiments, the system 100 may be personalized for specific users. More particularly, the answers to input question 104 by the QA system 106 may be based on the user. For example, the answers provided by QA system 106 may be based on how a specific user interacts with shallow analytic system 116. The shallow analytic system 116 may be any search-and-browse system. For example, a search-and-browse system may allow a user of user system 102 to navigate through a text repository, HTML web pages, or other content on web pages. Thus, for example, the shallow analytic system 116 may include a web browser that allows the user system 102 to access the internet to browse web pages and perform web searches utilizing a web search engine.

The document ingestion system 118 may include monitoring circuit 120, text analytics circuit 122, and a user specific document collection 124. The document ingestion system 118 may initiate a user specific document collection 124 for one or more specific users. For example, the document collection system 118 may initiate a user specific document collection 124 for one user of user system 102, a separate user specific document collection 124 for a second user of the user system 102, and/or a user from a different user system. The monitoring circuit 120 may be configured to monitor the shallow analytic system 116 and the interaction between the shallow analytic system 116 and the user system 102. For example, a user of the user system 102 may interact with documents in the shallow analytic system 116 (e.g., browse through different web pages, click different links in web pages, and/or perform web searches utilizing a search engine). The monitoring circuit 120 may be configured to monitor this activity. Based on this interaction between the user of the user system 102 and the shallow analytic system 116, the monitoring circuit 120 may obtain an indication that the user of the user system 102 is interested in one or more documents to be included as part of the corpus of data in the QA system 106. Thus, the user may personalize at least some of the documents that the QA system 106 may utilize to answer questions for the user.

The indication that user is interested in a document to be included in the corpus of data may be a direct or an indirect indication. For example, the document ingestion system 118 may include an interface element on web pages in the shallow analytic system 116. If a user determines that a specific document should be included in the corpus of data, the user may indicate intent to include the document through the interface element as a direct indication. For example, as a user of user system 102 reviews a specific web page, the document ingestion system 118 may include an “Include this” button as an interface element that the user may see. If the user selects the “Include this” button, then the document (i.e., web page) that the user is reviewing is flagged for inclusion in the corpus of data. An indirect indication may be a function of (i.e., based on) the number of times a user visits a specific document, the amount of active time the user spends with a specific document, and/or a similarity between a document that has already been selected for inclusion in the corpus of data and a second document. For example, a user may indicate to the document ingestion system 118 that if the user visits a particular document a threshold number of times, the document is to be included in the corpus of data. In alternative embodiments, the document ingestion system 118 may make the threshold determination without user input. If user visits to the particular document exceed the threshold value, the document is flagged for inclusion in the corpus of data. In some embodiments, indirectly indicated documents may be flagged for automatic inclusion into the corpus of data while in alternative embodiments, indirectly indicated documents may be flagged for adding to the corpus of data pending review by the user. For example, once a document has been flagged for inclusion in the corpus of data based on an indirect indication, that document may be presented to the user by the document ingestion system 118 for approval to include in the corpus of data.

Each document that has been flagged for inclusion in the corpus of data (and approved for inclusion in embodiments in which the user approves documents for inclusion) are then included (i.e., added) to the user specific document collection 124. The user specific document collection 124 (including each of the documents 126 flagged for inclusion) then may be ingested into the QA system 106. Text analytics circuit 122 may be configured to run one or more text analytic algorithms over the raw text in each of the documents 126. For example, text analytics circuit 122 may run one or more natural language processing algorithms (e.g., a parsing algorithm, a part of speech tagger, a named entity recognizer, a relationship extractor, etc.) over the raw text of the documents 126. These algorithms may leave annotations over the raw text which may be utilized by the QA system 106 to draw inferences. In other words, the text analytics circuit 122 translates the raw content of the documents 126 into something QA system 106 can understand. After the documents 126 have undergone the text analytic algorithms (thus, they include annotations), the documents along with the annotations may be stored in the databases 112 (memory) as at least a portion of documents 114, and thus are a part of the corpus of data.

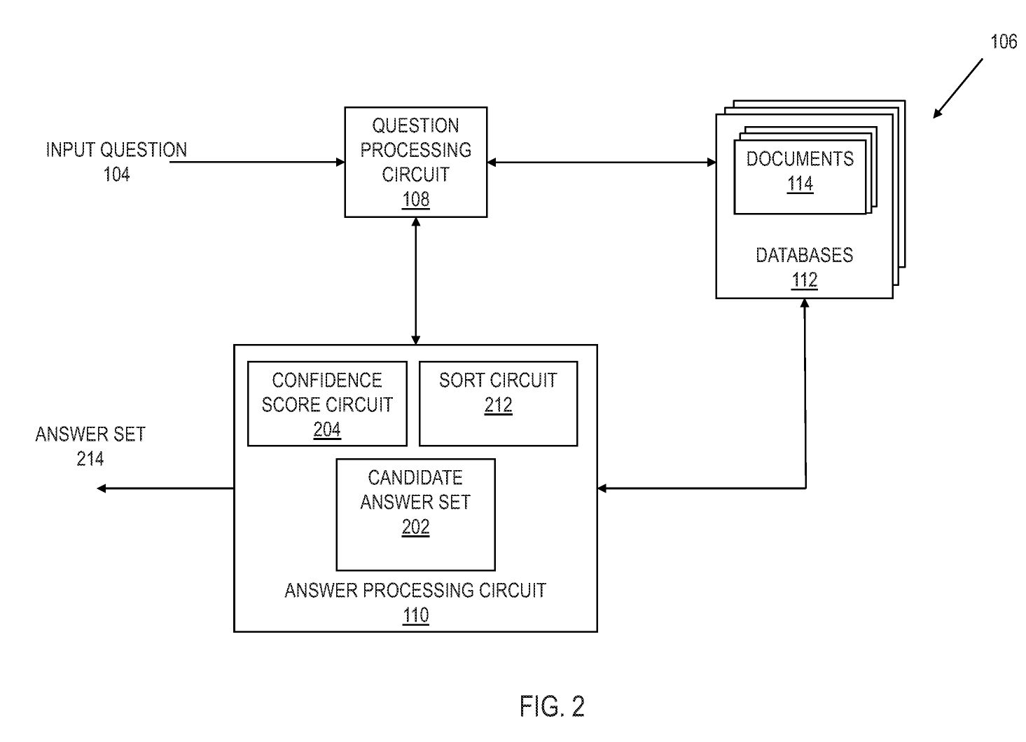

FIG. 2 shows an illustrative block diagram of QA system 106 for answering natural language questions in accordance with various embodiments. As discussed above, an input question 104 is received from the user system 102 by the question processing circuit 108. The question processing circuit 108 parses the input question 104 using natural language processing techniques to extract major features from the input question 104 which may then be used to decompose the question 104 into one or more queries that may be submitted to the databases 112 in order to generate one or more hypotheses. The submission of the queries results in the extraction of portions of the corpus of data/information matching the criteria of the particular query. These portions of the corpus are analyzed and used to generate a candidate answer set 202, each of the answers in the candidate answer set 202 providing an answer to the input question 104.

For example, the answer processing circuit 110 may determine a number of candidate answers to the question, “Which basketball team is from New York?” that are included in the set of candidate answers 202. Thus, the candidate answer set 202 in this example may include, the New York Knicks, the Brooklyn Nets, the New York Liberty, the St. John's Red Storm, the Fordham Rams, the Harlem Globetrotters, etc. Along with generating the candidate answer set 202, the answer processing circuit 110 may pull evidence passages (text passages) from the databases 112 and documents 114 that provide evidence that supports the particular candidate answer set 202. For example, a query submitted to the databases 112 may return portions of the corpus of data/information as an evidence passage that states, “The New York Knicks are a professional basketball team based in New York City.” From that evidence passage, the candidate answer New York Knicks may be extracted. Furthermore, the answer processing circuit 110 may determine whether the evidence passage that supports the answer is from a user specific document 126 that was ingested into QA system 106 from the user specific document collection 124. In other words, the answer processing circuit 110 may determine if a particular answer in the candidate answer set 202 was generated from a document in the user specific document collection 124.

The confidence score circuit 204 may generate confidence scores for each of the answers contained in the candidate answer set 202. The confidence score circuit 204 may synthesize the large number of relevance scores generated by the various reasoning algorithms into confidence scores for the various answers in the candidate answer set 202. For example, confidence score circuit 204 may generate a confidence score for each answer based on the number of documents 114 a candidate answer appears. Additionally, the confidence score circuit 204 may generate a confidence score for each answer based on whether the particular answer was generated from a document in the user specific document collection 124. This process may involve applying weights to the various scores. The weighted scores may be processed in accordance with a statistical model to generate a confidence score or measure for the individual answers. In an embodiment, an answer that was generated from a document in the user specific document collection 124 may be provided more weight than an answer that was generated from a document that was not in the user specific document collection 124. In other words, the confidence score circuit 204 may generate a confidence score that is higher for an answer that was generated from a document in the user specific document collection 124 than for an answer that was generated from a document that was not in the user specific document collection 124.

In an example, the input question 104, “Which basketball team is from New York?” may generate a candidate answer set 202 that includes the New York Knicks, the Brooklyn Nets, the New York Liberty, the St. John's Red Storm, the Fordham Rams, the Harlem Globetrotters. If the user specific document collection 124 contains only documents that include NBA teams, then the NBA teams may elicit higher confidence scores. Thus, confidence score circuit 204 may generate a confidence score of 40% for the New York Knicks and the Brooklyn Nets. However, the remaining candidate answers from the candidate answer set 202 are not NBA teams, and thus, are not included in documents in the user specific document collection 124. Therefore, they may elicit lower confidence scores (at least less than the confidence scores of the answers generated from documents included in the user specific document collection 124). For example, confidence score circuit 204 may generate a confidence score of 5% for the New York Liberty, St. John's Red Storm, Fordham Rams, and Harlem Globetrotters.

The sort circuit 212 is configured to compare the confidence scores determined by the confidence score circuit 204 to generate answer set 214 to be returned to the user system 102. The answer set 214 may include each of the answers from the candidate answer set 202 and/or any combination of answers from the candidate answer set 202. In an embodiment, the sort circuit may generate the answer set 214 to include only answers from the candidate answer set that have confidence scores that exceed a threshold value. The sort circuit 212 may also be configured to sort the confidence scores of the answers in the answer set 214. In an embodiment, the sort circuit 212 may sort the confidence scores of the answer set 214 from the greatest confidence score to the least confidence score and return the answer set 214 to the user system 102 in order from greatest confidence score to least confidence score. In alternative embodiments, the answer set 214 may be returned to the user system 102 in any order. In this manner, a user of the user system 102 may be provided with personalized high quality answers to an input question 104.

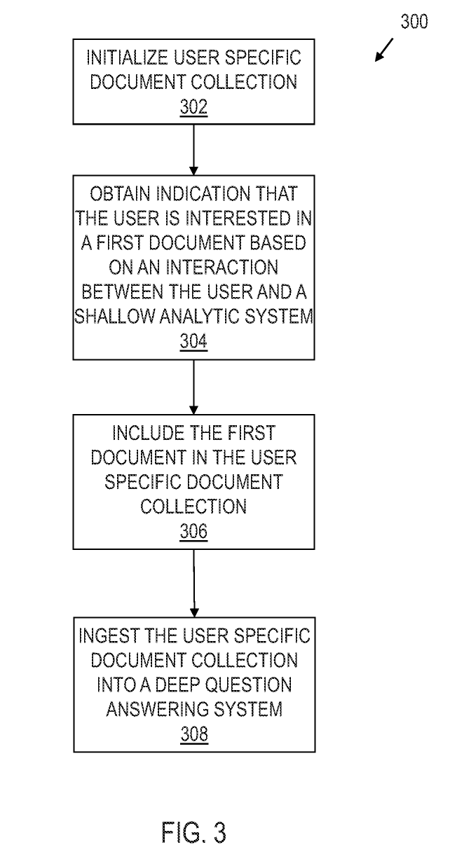

FIG. 3 shows a flow diagram illustrating aspects of operations that may be performed to ingest user specific documents into a deep question answering system in accordance with various embodiments. Though depicted sequentially as a matter of convenience, at least some of the actions shown can be performed in a different order and/or performed in parallel. Additionally, some embodiments may perform only some of the actions shown. In some embodiments, at least some of the operations of the method 300 may be provided by instructions executed by a computer of the system 100.

The method 300 begins in block 302 with initializing a user specific document collection. For example, a user specific document collection, such as user specific document collection 124, may be initialized in a document ingestion system, such as document ingestion system 118, to store documents to be ingested into a deep QA system, such as QA system 106. In block 304, the method 300 continues with obtaining an indication that the user is interested in a first document based on an interaction between the user and a shallow analytic system. For example, the document ingestion system may monitor a user's interaction with a shallow analytic system, such as shallow analytic system 116. The indication may be a direct indication and/or an indirect indication.

The method 300 continues in block 306 with including the first document in the user specific document collection. For example, the first document may be stored in the user specific document collection. In block 308, the method 300 continues with ingesting the user specific document collection into the deep QA system. For example, a text analytics circuit, such as text analytics circuit 122, may run one or more text analytic algorithms over the raw text of one or more of the documents in in the user specific document collection (including the first document). The annotations generated by the text analytic algorithms then may be stored, in some cases along with the documents themselves, in memory accessible to the deep QA system, such as in the databases 112.

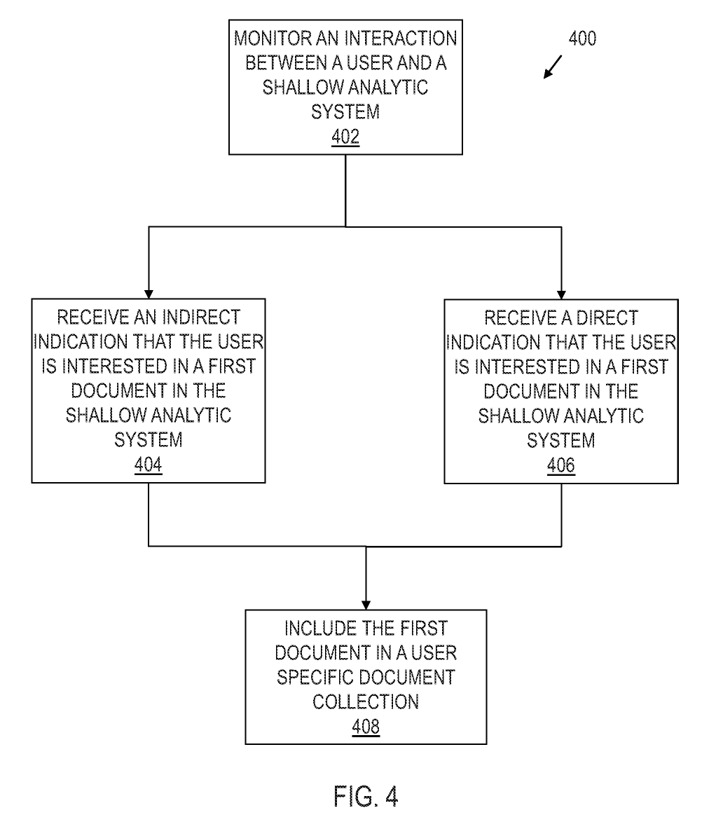

FIG. 4 shows a flow diagram illustrating aspects of operations that may be performed to identify user specific documents to include for ingestion into a deep question answering system in accordance with various embodiments. Though depicted sequentially as a matter of convenience, at least some of the actions shown can be performed in a different order and/or performed in parallel. Additionally, some embodiments may perform only some of the actions shown. In some embodiments, at least some of the operations of the method 400 may be provided by instructions executed by a computer of the system 100.

The method 400 begins in block 402 with monitoring an interaction between a user and a shallow analytic system. For example, a monitoring circuit, such as monitoring circuit 120, in a document ingestion system, such as document ingestion system 118, may monitor the interaction between a user system, such as user system 102, and a shallow analytic system, such as shallow analytic system 116. In block 404, the method 400 continues with receiving an indirect indication that the user is interested in a first document in the shallow analytic system. For example, the monitoring circuit may monitor the number of times a user visits a specific document, the amount of active time the user spends with a specific document, and/or a similarity between a document that has already been selected for inclusion in a corpus of data in a deep QA system, such as QA system 106, and a document. If, for example, user visits to the first document exceed a threshold value, the document is flagged for inclusion in the corpus of data of the deep QA system. In some embodiments, indirectly indicated documents may be flagged for automatic inclusion into the corpus of data in the deep QA system while in alternative embodiments, indirectly indicated documents may be flagged for adding to the corpus of data in the deep QA system pending review by the user.

The method 400 may also continue in block 406 with receiving a direct indication that the user is interested in a first document in the shallow analytic system. For example, the document ingestion system may include an interface element on web pages in the shallow analytic system. If a user determines that a specific document should be included in the corpus of data in the deep QA system, the user may indicate intent to include the document through the interface element as a direct indication. For example, as a user of user system reviews a specific web page, the document ingestion system may include an “Include this” button as an interface element that the user may see. If the user selects the “Include this” button, then the document (i.e., web page) that the user is reviewing is flagged for inclusion in the corpus of data in the deep QA system.

In block 408, the method 400 continues with including the first document in a user specific document collection. For example, once the document ingestion system receives the indirect indication and/or direct indication that the user is interested in the first document, the first document is included (i.e., stored) in a user specific document collection, such as user specific document collection 124.

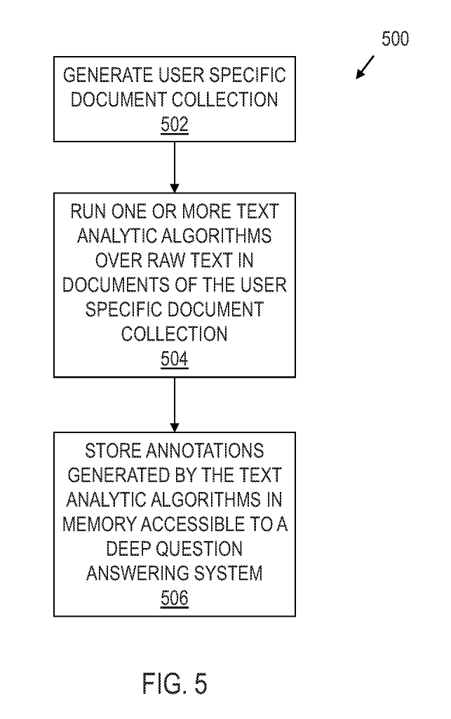

FIG. 5 shows a flow diagram illustrating aspects of operations that may be performed to ingest user specific documents into a deep question answering system in accordance with various embodiments. Though depicted sequentially as a matter of convenience, at least some of the actions shown can be performed in a different order and/or performed in parallel. Additionally, some embodiments may perform only some of the actions shown. In some embodiments, at least some of the operations of the method 500 may be provided by instructions executed by a computer of the system 100.

The method 500 begins in block 502 with generating a user specific document collection. For example, a user specific document collection, such as user specific document collection 124, may be initialized in a document ingestion system, such as document ingestion system 118, to store documents to be ingested into a deep QA system, such as QA system 106. Documents may be added to the user specific document collection in response to an indication (either direct or indirect) that the user is interested in a specific document. The indication may be based on an interaction between the user and a shallow analytic system, such as shallow analytic system 116.

In block 504, the method 500 continues with running one or more text analytic algorithms over the raw text in the documents of the user specific document collection. For example, a text analytics circuit, such as text analytics circuit 122, of the document ingestion system may run one or more natural language processing algorithms (e.g., a parsing algorithm, a part of speech tagger, a named entity recognizer, a relationship extractor, etc.) over the raw text of the documents in the user specific document collection. These algorithms may leave annotations over the raw text which may be utilized by the deep QA system to draw inferences. In other words, the text analytics circuit may translate the raw content of the documents in the user specific document collection into something a deep QA system can understand.

The method 500 continues in block 506 with storing the annotations generated by the text analytic algorithms in memory accessible to the deep QA system. For example, after the documents in the user specific document collection have undergone the text analytic algorithms (thus, they include annotations), the documents along with the annotations may be stored in a memory that is accessible to the deep QA system for answering a user's questions.

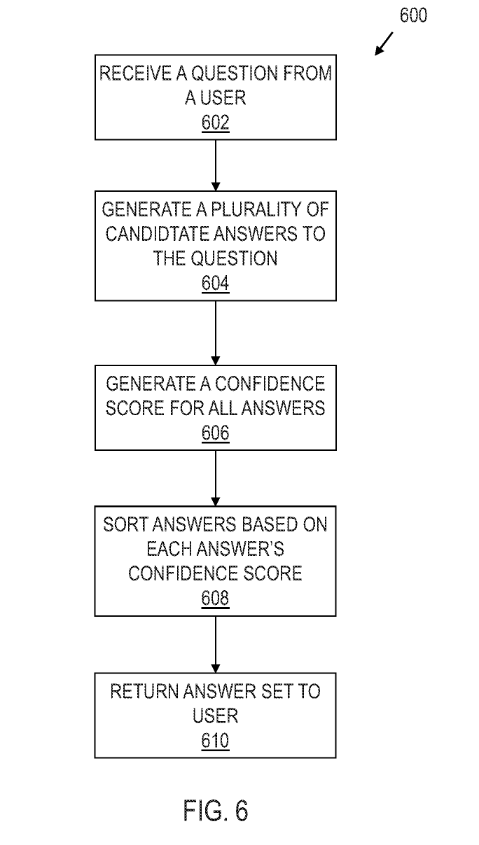

FIG. 6 shows a flow diagram illustrating aspects of operations that may be performed to answer natural language questions utilizing a deep question answering system in accordance with various embodiments. Though depicted sequentially as a matter of convenience, at least some of the actions shown can be performed in a different order and/or performed in parallel. Additionally, some embodiments may perform only some of the actions shown. In some embodiments, at least some of the operations of the method 600 may be provided by instructions executed by a computer of the system 100.

The method 600 begins in block 602 with receiving a question from a user. For example, an input question, such as input question 104, may be received from a user system, such as user system 102. More particularly, the question may be received by a question processing circuit, such as question processing circuit 108, of a deep QA system, such as QA system 106. In block 604, the method 600 continues with generating a plurality of candidate answers to the question. For example, the question processing circuit may parse the question and generate one or more queries that may be submitted to one or more databases, such as databases 112, of the deep QA system in order to generate one or more hypotheses. The submission of the queries results in the extraction of portions of the corpus of data/information matching the criteria of the particular query. These portions of corpus are analyzed and used to generate, in some embodiments by an answer processing circuit, such as answer processing circuit 110, a candidate answer set, such as candidate answer set 202.

The method 600 continues in block 606 with generating a confidence score for all of the answers in the candidate answer set. For example, a confidence score circuit, such as confidence score circuit 204, in the answer processing circuit may synthesize the large number of relevance scores generated by the various reasoning algorithms utilized to generate the answers into confidence scores for the various answers in the candidate answer set. The confidence scores may be generated based on whether a particular answer in the candidate answer set was generated from a document in a user specific document collection, such as user specific document collection 124. This process may involve applying weights to the various scores. The weighted scores may be processed in accordance with a statistical model to generate a confidence score or measure for the individual answers. An answer that was generated from a document in the user specific document collection may be provided more weight than an answer that was generated from a document that was not in the user specific document collection. In alternative embodiments, a confidence score may be generated for a subset of the answers in the candidate answer set (e.g., one or more of the answers in the candidate answer set, but not all of the answers in the candidate answer set).

In block 608, the method 600 continues with sorting answers in the candidate answer set based on each answer's confidence score. For example, a sort circuit, such as sort circuit 212, in the answer processing circuit may compare the confidence scores of the answers in the candidate answer set. The sort circuit may sort the confidence scores for the answers of the candidate answer set from the greatest confidence score to the least confidence score. The method 600 continues in block 610 with returning an answer set to the user. For example, the sorted answers in the candidate answer set may included in an answer set, such as answer set 214, that is returned to the user system.

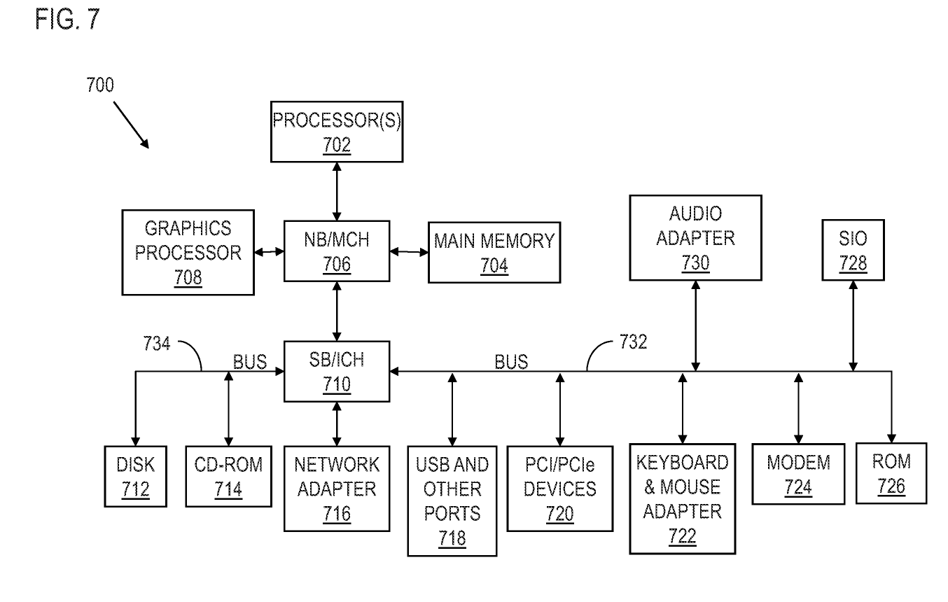

FIG. 7 is a block diagram of an example data processing system in which aspects of the illustrative embodiments may be implemented. Data processing system 700 is an example of a computer that can be applied to implement the user system 102, the shallow analytic system 116, the document ingestion system 118, and/or the QA system 106 in FIG. 1 and FIG. 2, in which computer usable code or instructions implementing the processes for illustrative embodiments of the present invention may be located. In one illustrative embodiment, FIG. 7 represents a computing device that implements the document ingestion system 118 and QA system 106 augmented to include the additional mechanisms of the illustrative embodiments described hereafter.

In the depicted example, data processing system 700 employs a hub architecture including north bridge and memory controller hub (NB/MCH) 706 and south bridge and input/output (I/O) controller hub (SB/ICH) 710. Processor(s) 702, main memory 704, and graphics processor 708 are connected to NB/MCH 706. Graphics processor 708 may be connected to NB/MCH 706 through an accelerated graphics port (AGP).

In the depicted example, local area network (LAN) adapter 716 connects to SB/ICH 710. Audio adapter 730, keyboard and mouse adapter 722, modem 724, read only memory (ROM) 726, hard disk drive (HDD) 712, CD-ROM drive 714, universal serial bus (USB) ports and other communication ports 718, and PCI/PCle devices 720 connect to SB/ICH 710 through bus 732 and bus 734. PCI/PCle devices may include, for example, Ethernet adapters, add-in cards, and PC cards for notebook computers. PCI uses a card bus controller, while PCle does not. ROM 726 may be, for example, a flash basic input/output system (BIOS).

HDD 712 and CD-ROM drive 714 connect to SB/ICH 710 through bus 734. HDD 712 and CD-ROM drive 714 may use, for example, an integrated drive electronics (IDE) or serial advanced technology attachment (SATA) interface. Super I/O (SIO) device 728 may be connected to SB/ICH 710.

An operating system runs on processor(s) 702. The operating system coordinates and provides control of various components within the data processing system 700 in FIG. 7. In some embodiments, the operating system may be a commercially available operating system such as Microsoft® Windows 10®. An object-oriented programming system, such as the Java™ programming system, may run in conjunction with the operating system and provides calls to the operating system from Java™ programs or applications executing on data processing system 700.

In some embodiments, data processing system 700 may be, for example, an IBM® eServer™ System p® computer system, running the Advanced Interactive Executive (AIX®) operating system or the LINUX® operating system. Data processing system 700 may be a symmetric multiprocessor (SMP) system including a plurality of processors 702. Alternatively, a single processor system may be employed.

Instructions for the operating system, the object-oriented programming system, and applications or programs are located on storage devices, such as HDD 712, and may be loaded into main memory 704 for execution by processor(s) 702. The processes for illustrative embodiments of the present invention may be performed by processor(s) 702 using computer usable program code, which may be located in a memory such as, for example, main memory 704, ROM 726, or in one or more peripheral devices 712 and 714, for example.

A bus system, such as bus 732 or bus 734 as shown in FIG. 7, may include one or more buses. The bus system may be implemented using any type of communication fabric or architecture that provides for a transfer of data between different components or devices attached to the fabric or architecture. A communication unit, such as modem 724 or network adapter 716 of FIG. 7, may include one or more devices used to transmit and receive data. A memory may be, for example, main memory 704, ROM 726, or a cache such as found in NB/MCH 706 in FIG. 7.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or eternal storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method, comprising:
initializing a user specific document collection, the user specific document collection being specific to a user;
obtaining an indication that the user is interested in a first document based on an interaction between the user and a shallow analytic system;
including the first document in the user specific document collection; and
ingesting the user specific document collection into a deep question answering system.

2. The method of claim 1, further comprising, monitoring the interaction between the user and the first document in the shallow analytic system;
wherein the indication that the user is interested in the first document is an indirect indication.

3. The method of claim 2, wherein the indirect indication is based on a number of times the user visits the first document, an amount of active time the user spends with the first document, or a similarity between the first document to a second document that is included in the user specific document collection.

4. The method of claim 1, further comprising, monitoring the interaction between the user and the first document in the shallow analytic system;
wherein the indication that the user is interested in the first document is a direct indication from the user to include the first document in the user specific document collection.

5. The method of claim 1, wherein, ingesting the user specific document collection includes:
running one or more text analytic algorithms over raw text in the first document; and
storing annotations generated by the one or more text analytic algorithms in memory accessible to the deep question answering system.

6. The method of claim 1, further comprising:
receiving a question from the user;
generating a first answer to the question; and
generating a first confidence score for the first answer, the first confidence score being based on the first answer being generated from any document in the user specific document collection.

7. The method of claim 6, further comprising:
generating a second answer to the question; and
generating a second confidence score for the second answer, the second confidence score being based on the second answer being generated from any document not in the user specific document collection;
wherein the second confidence score is less than the first confidence score.

8. A system, comprising:
a deep question answering system executed by a computer;
a processor; and
a memory coupled to the processor, the memory encoded with instructions that when executed cause the processor to provide a document ingestion system for ingesting user specific documents into the deep question answering system, the document ingestion system configured to:
initialize a user specific document collection, the user specific document collection being specific to a user;
obtain an indication that the user is interested in a first document based on an interaction between the user and a shallow analytic system;
include the first document in the user specific document collection; and
ingest the user specific document collection into the deep question answering system.

9. The system of claim 8, wherein the document ingestion system is further configured to monitor the interaction between the user and the first document in the shallow analytic system;
wherein the indication that the user is interested in the first document is an indirect indication.

10. The system of claim 9, wherein the indirect indication is based on a number of times the user visits the first document, an amount of active time the user spends with the first document, or a similarity between the first document to a second document that is included in the user specific document collection.

11. The system of claim 8, wherein the document ingestion system is further configured to monitor the interaction between the user and the first document in the shallow analytic system;
wherein the indication that the user is interested in the first document is a direct indication from the user to include the first document in the user specific document collection.

12. The system of claim 8, wherein the document ingestion system is configured to ingest the user specific document collection by:
running one or more text analytic algorithms over raw text in the first document; and
storing annotations generated by the one or more text analytic algorithms in memory accessible to the deep question answering system.

13. The system of claim 10, wherein the deep question answering system is configured to:
receive a question from the user;
generate a first answer to the question; and
generate a first confidence score for the first answer, the first confidence score being based on the first answer being generated from any document in the user specific document collection.

14. The system of claim 13, wherein the deep question answering system is configured to:
generate a second answer to the question; and
generate a second confidence score for the second answer, the second confidence score being based on the second answer being generated from any document not in the user specific document collection;
wherein the second confidence score is less than the first confidence score.

15. A computer program product for ingesting user specific documents into a deep question answering system, the computer program product comprising a computer readable storage medium having program instructions embodied therewith, the program instructions executable by a computer to cause the computer to:
initialize a user specific document collection, the user specific document collection being specific to a user;
obtain an indication that the user is interested in a first document based on an interaction between the user and a shallow analytic system;
include the first document in the user specific document collection; and
ingest the user specific document collection into the deep question answering system.

16. The computer program product of claim 15, wherein the program instructions are further executable by the computer to cause the computer to monitor the interaction between the user and the first document in the shallow analytic system;
wherein the indication that the user is interested in the first document is an indirect indication.

17. The computer program product of claim 16, wherein the indirect indication is based on a determination that a number of times the user visits the first document is greater than a threshold value.

18. The computer program product of claim 16, wherein the indirect indication is based on an amount of active time the user spends with the first document or a similarity between the first document to a second document that is included in the user specific document collection.

19. The computer program product of claim 15, wherein the program instructions are further executable by the computer to cause the computer to monitor the interaction between the user and the first document in the shallow analytic system;
wherein the indication that the user is interested in the first document is a direct indication from the user to include the first document in the user specific document collection.

20. The computer program product of claim 19, wherein the program instructions are further executable by the computer to cause the computer to ingest the user specific document collection by:
running one or more text analytic algorithms over raw text in the first document; and
storing annotations generated by the one or more text analytic algorithms in memory accessible to the deep question answering system.
